(19) United States
(12) Patent Application Publication
(10) Pub. No.: US 2008/0271637 A1
(43) Pub. Date: Nov. 6, 2008

(54) POTATO EXTRACT AND METHODS FOR USE

(76) Inventor: Aaron DeWald, St. Ann, MO (US)

Correspondence Address: HAVERSTOCK, GARRETT & ROBERTS LLP, 611 OLIVE STREET, SUITE 1610, ST. LOUIS, MO, 63101, US

(21) Appl. No.: 12/114,543

(22) Filed: May 2, 2008

Related U.S. Application Data
(60) Provisional application No. 60/927,253, filed on May 2, 2007.

(51) Int. Cl. C08L 1/00

(52) U.S. Cl. 106/163.01

(57) ABSTRACT

A thermally resistant stable composition comprising potato extract and method for making the same is disclosed.

This application claims the benefit of U.S. Provisional Application No. 60/927,253, filed May 2, 2007, and my co-pending U.S. patent application Ser. No. 11/300,857, filed Dec. 15, 2005.

### TECHNICAL FIELD

This invention relates to extracts from vegetables in the potato group or family, particularly the genus Solanum and the genus Lycopersicon, which extracts may be used as protective coatings.

### BACKGROUND ART

U.S. Provisional Application No. 60/927,253, filed May 2, 2007, is incorporated herein in its entirety by reference.

A wide variety of chlorine-generating solid compositions, capable of releasing chlorine at ambient temperatures when contacted with fluid media, have been particularly useful for sanitizing bacteria and other micro-organisms in swimming pools. Materials such as polyvinylpyrrolidone (PVP) and chlorinated paraffins are other materials which have been employed. There have been a number of drawbacks to each of those products. Such products were initially disclosed for the use as protective coatings in U.S. Pat. No. 3,647,523 by Horvath, et al.

In my co-pending patent application Ser. No. 11/300,857, I discuss a number of drawbacks to the use of PVP and waxy paraffins. Compositions containing denatured aloe vera has been offered as an improved protective composition overcoming prior art drawbacks.

Coating compositions that would improve the performance of denatured aloe vera even further could substantially advance the art.

### SUMMARY OF THE INVENTION

In the present invention, extracts from potatoes, as for example, russet potatoes, when reduced by, for example, acetic acid and then heated and mixed with aloe vera, oil, and/or for example, acetic acid, and further heating until a gel forms, and then by re-hydrating the gel, the composition can be used as protective coatings for solid hazardous materials, especially calcium hypochlorite. When re-hydrating the gel, it becomes stable to temperatures as high as 220° F., where previously even with protective coatings, it could only be stable to 160° F. The coated calcium hypochlorite, even often being coated remains soluble in water. The process enables chemicals such as calcium hypochlorite to be reclassified and shipped and stored as non-hazardous materials under current EPA standards.

### DETAILED DESCRIPTION OF THE INVENTION

In the process of the present invention, extracts are prepared from vegetables in the potato group or family, particularly the genus Solanum and the genus Lycopersicon, preferably russet potatoes. Potatoes are employed as raw materials in the process of this invention and are initially grated or comminuted to break the material down into small particles, or shreds. As the potatoes are shredded, liquid is drained off of the product, and water is used to extract extraneous materials from the potatoes and the material is dried, leaving primarily the protein and starch in solid form. Continued liquid separation of the solid potato material can be achieved by other non-toxic solvent extractions so long as the pH remains substantially neutral. Conventional liquid extraction procedures may be employed. The liquid is passed through potato and solids are precipitated from the liquid in 2 to 10 passes to condense the recipitent. Initially the latent liquid is black but becomes clear. Next, the extracted potato solids are reduced in acetic acid and heated at, for example, 120° F. to 160° F. Sufficient acetic acid, as for example, a concentration equivalent of vinegar, may be employed together with slight stirring, produces a rubber-like gel. The rubbery gel is then admixed with denatured aloe vera as prepared in my co-pending application Ser. No. 11/300,857 (which is herein incorporated by reference). Also pure aloe vera may be used and denatured in situ when reducing the potato solids In a weight-to-weight proportion of 1:5 to 5:1 of the potato solids are admixed with denatured aloe vera. The mixture is heated until a homogenous gel is obtained. This heating stage can take place at from about 120° F. to about 160° F. From this mixture, two parts of the mixture are added to from three to six parts water in order to re-hydrate the potato extract. Although this is conducted at room temperature, it can be heated to as high as 100° F. It should be noted that this re-hydration must be separated from the prior heating step by allowing the intermediate product to cool before re-hydration in order for the preferred product stability.

It will be noted that the product is stable to 220° F. Accordingly, the process is a five-stage process, including (1) solid/liquid extraction, preferably water extraction of potato solids; (2) acetic reduction by a mild acid; (3) admixture with denatured aloe vera; (4) initial heating stage and cool down; and (5) hydration stage or more preferably, re-hydration stage and continued heating.

It is noted that when the denatured aloe vera product is added, that product can be mixed with oil, vegetable fat or fat of animal varieties such as lanolin as discussed in my co-pending application Ser. No. 11/300,857. Unlike my prior application, vegetable oil can be employed herein.

It is to be noted that the final product material is resistant to heat degradation at temperatures as high as 220° F. and higher.

The final product in its re-hydrated form can be coated over chemicals such as calcium hypochlorite and will protect the calcium hyperchloride although remaining soluble in water. The calcium hyperchloride will be protected without degradation and can be shipped at temperatures as high as 220° F. without any chlorine being detected.

Prior to re-hydration, the material is a rubbery gel and can be used as a substitute for or in making other products including, for example, plasticizers. The gel can be molded and will substitute for certain type of thermoplastic or rubber materials. The product can be ground into particles and added to liquids or solids when one desires to make such materials more stable at high temperatures against reactivity, or breakdown of any type. The product can be converted and used, for example, as a lubricant or as a material to absorb oily substances. It could also be used for temperature control where it can, for example, make organic systems less susceptible to temperature fluctuation, and can be used to coat medicines, food, etc. The potato extract can also serve as a barrier layer against attack from micro-organisms.

Many chemicals are hygroscopic, such as bromine. That is, bromine products will agglomerate, cake up, or clump and can lose their reactivity in doing so. The present potato extract composition has been found to keep the bromine products free flowing and non-agglomerated.

Additionally, the material of the present invention can be added to thicken liquids so as to make them more gel-like or even to solidify certain liquid materials. In waste management, for example, the potato extract materials of this invention can be employed to process waste materials into a more manageable form. In production facilities, the potato extracts may be used as a vehicle for forming liquid media in gels, prior to molding or casting the materials. Water and aqueous based liquids are readily absorbed by the potato extract products of this invention.

The product of the present invention may be used as an oil extender. For example, the products of the present invention can constitute 55 to 70% of a mixture containing other oils that constitute 30 to 45% of the mixture. Such products are homogenous liquids and/or gels which may behave very similarly to petroleum based products. They can be used as diluents for extending petroleum based products such as heating oil, lubricating oils, or even gasoline or fuel.

Products of the present invention may constitute material which augments and/or partially substitutes the resin component in paints, and protective coatings for building and construction materials.

Antiseptics, medicine, vitamins, colorants, etc. can be added to the composition of the present invention for converting it to useful applications such as liquid or gel-type bandages and antiseptics.

Also, products of the present invention can be used to form a non-stick coating. That is, products of this invention can be used as coatings for utensils and cooking or reaction vessels where food, reactants, etc. will not stick to the lining of the utensil or vessel, even at high temperatures. Accordingly, such coatings on the inside of reaction vessels can improve the flow characteristics of properties of the vessel content, while also decreasing reactivity during chemical processing. Organic non-stick products are usually unstable at elevated temperatures, however, by adding potato extract type materials to such products, they can maintain their non-stick properties at elevated temperatures.

### EXAMPLES

Potato solids were water extracted and substantially dried using several extractions. These materials were then dried and reduced in acetic acid and mixed with aloe vera or oil. The acid reduction took place at 100° F. to 120° F. and occurred with the amounts of vinegar indicated in the Tables below. These materials were then mixed with amounts of denatured aloe vera in the amounts identified in Tables I and II and were successfully employed as products identified in Tables I and II below. The products were found to be stable at the temperatures indicated in Tables I and II and their solubilities are described as well as other characteristics.

TABLE I

| | | | | % Weight | | | |
|---|---|---|---|---|---|---|---|
| | | | | Mineral | | | |
| | | | % Weight | Oil/ | | | |
| Sample | Use of | Potato | Denatured | Vegetable | % Weight | % Ethyl | |
| No. | Product | Extract | Aloe Vera | Oil | Vinegar | Alcohol | % H₂O |
| 1 | Plasticizer | 50-83% | — | — | 17-50% | — | — |
| | (plastic/ | | | | | | |
| | rubber | | | | | | |
| | substitute) | | | | | | |
| 2 | Lubricant | 38-55% | — | 23-29% | 38-48% | — | — |
| | (oil | | | | | | |
| | absorbent) | | | | | | |
| 3 | Temperature | 95-99% | — | — | 1-5% | — | — |
| | control | | | | | | |
| | adjustor | | | | | | |
| 4 | Oil | 36% | 18% | — | 27% | 18% | — |
| | substitute | | | | | | |
| 5 | Food | 31% | 25% | 13% (veg) | 31% | — | — |
| | absorber | | | | | | |
| 6 | Moisture | 36% | 36% | — | 27% | — | — |
| | reducer | | | | | | |
| 7 | Hazardous | 27% | 27% | 13% (veg) | 33% | — | — |
| | dry | | | | | | |
| | chemical | | | | | | |
| | coating | | | | | | |
| 8 | Thickening | 1-29% | 0 | — | 3-36% | — | 36-96% |
| | agent or | | | | | | |
| | absorber | | | | | | |
| | for liquids | | | | | | |
| 9 | Water | 1-21% | 0 | — | 3-36% | — | 36-96% |
| | purifier | | | | | | |
| 10 | Oil | 10-13% | 20-25% | 31-45% | 15-19% | 10-13% | — |
| | extender | | | | | | |
| 11 | Paint | 7% | 60% | 15% | 11% | 7% | — |
| 12 | Food and | 6-8% | 66-69% | 4% (veg) | 12% | 8% | — |
| | medicine | | | | | | |
| | coating | | | | | | |

TABLE II

| | Use Of | | Stable At | | |
|---|---|---|---|---|---|
| Sample No. | Product | Appearance | Temperature | Solubility | Other |
| 1 | Plasticizer | Rubbery, | over 220° F. | Insoluble | Clear |
| | (plastic/ | hard solid | | | |
| | rubber | | | | |
| | substitute) | | | | |
| 2 | Lubricant | Oily, | over 220° F. | Insoluble | Clear |
| | (oil | rubbery hard | | | |
| | absorbent) | solid | | | |
| 3 | Temperature | Fluid to | 10° F. to | Completely | |
| | control | solid | over 22° F. | soluble to | |
| | adjustor | | | insoluble | |
| 4 | Oil | Thick oil, | 140° F. to | Low | |
| | substitute | gel-like | 150° F. | | |
| 5 | Food | Fluid to | 10° F. to | Completely | Clear |
| | absorber | solid | 180° F. | soluble to | |
| | | | | insoluble | |
| 6 | Moisture | Thick gel | 180° F. to | Low to | Bromine, |
| | reducer | | 220° F. | moderate | etc. |
| 7 | Hazardous | Thick gel | 180° F. to | Low to | Chlorine, |
| | dry chemical | | 220° F. | moderate | Bromine |
| | coating | | | | |
| 8 | Thickening | Fluid to | 10° F. to | Moderate to | Bacterial |
| | agent or | thick gel | 150° F. | high | barrier |
| | absorber for | | | | |
| | liquids | | | | |
| 9 | Water | Fluid to | 10° F. to | Moderate to | Bacterial |
| | purifier | thick gel | 150° F. | high | barrier |
| 10 | Oil extender | Thick oil to | 10° F. to | Low | |
| | | gel-like | 130° F. | | |
| 11 | Paint | Viscous | 10° F. to | Low | Dries 5-10 mins. |
| | | liquid | 130° F. | | |
| 12 | Food and | Thin liquid | 10° F. to | High | Dries 5-10 mins. |
| | medicine | | 120° F. | | |
| | coating | | | | |

What is claimed is:

1. A heat resistant stable composition up to temperatures of 220° F. comprising water solvent extracted re-hydrated potato solids at slightly acid pH.

2. The potato extract composition of claim 1 further comprising denatured aloe vera.

3. The products of claim 1 further comprising denatured aloe vera, oils selected from mineral oil, vegetable oil, or animal oil, and further comprising ethyl alcohol.

4. The products of claim 1 comprising 50-83% potato extract and 17-50% acetic acid and used as a plasticizer.

5. A thermo-resistant composition of matter for coating hazardous chemicals comprising potato extract, denatured aloe vera, oil, and acetic acid.

6. A heat-resistant composition of matter comprising from 1 to 99% water or solvent extracted potato extract, from 0 to 60% aloe vera, from 0 to 45% oil, from 1 to 48% vinegar, from 0 to 18% ethyl alcohol, and from 0 to 96% water.
